(19) United States
(12) Patent Application Publication
(10) Pub. No.: US 2025/0193489 A1
(43) Pub. Date: Jun. 12, 2025

(54) METHOD AND DEVICE FOR REFLECTING PUBLIC MOOD DURING A REAL-TIME TRANSMISSION

(71) Applicant: Dr. Ing. h.c. F. Porsche Aktiengesellschaft, Stuttgart (DE)

(72) Inventors: Nikolay Dreharov, Ludwigsburg (DE); Moritz Hornung, Remseck (DE)

(73) Assignee: Dr. Ing. h.c. F. Porsche Aktiengesellschaft, Stuttgart (DE)

(21) Appl. No.: 18/281,330

(22) PCT Filed: Feb. 23, 2022
(86) PCT No.: PCT/EP2022/025060

§ 371 Date: Sep. 11, 2023

(30) Foreign Application Priority Data
Apr. 19, 2021 (DE) 10 2021 109 778.9

(51) Int. Cl. H04N 21/442; H04N 21/4223

(52) U.S. Cl. CPC H04N 21/44218

(57) ABSTRACT

A method for reflecting public mood during a real-time transmission, which is played simultaneously on multiple clients. During the real-time transmission, reactions of users of the clients are recorded. The recorded reactions are statistically compressed on a server to give a representative overall mood among the users and the overall mood is conveyed by a display.

### CROSS-REFERENCE TO RELATED APPLICATIONS

This U.S. national phase patent application claims priority to PCT International Patent Application No. PCT/EP2022/025060, filed Feb. 23, 2022, which claims priority to German Patent Application No. 10 2021 109 778.9, filed Apr. 19, 2021, the contents of each application being incorporated by reference herein in its entirety.

### FIELD OF THE INVENTION

The present invention relates to a method for reflecting public mood during a real-time transmission. The present invention further relates to a corresponding device, a corresponding computer program, and a corresponding machine-readable storage medium.

### BACKGROUND OF THE INVENTION

Real-time transmission (livestreaming) is a media offering that is provided in real-time via a computer network and is played during the transmission in progress. Interactive offers of this genus via the internet are known as so-called webcasts to the person skilled in the art.

In the following, the term “real-time transmission” is nevertheless used in a broad sense, independent of the transmission channel, which in particular includes live or direct transmissions on radio and television.

### SUMMARY OF THE INVENTION

The invention provides a method for reflecting public mood during real-time transmission of an event, a corresponding device, a corresponding computer program, and a corresponding machine-readable storage medium according to the independent claims.

A preferred aspect of this solution is the suitability of the real-time data obtained according to the invention for accurately describing the current overall mood and for being visually or acoustically presented at any number of endpoints.

Further advantageous configurations of the invention are specified in the dependent claims. Thus, the viewer reactions can be recorded during real-time transmission by a mobile app or web application, which also serves to display the overall mood. In this way, each user of this web component or mobile app is enabled to follow the mood, emotions, and reactions of the other users through the visualized and possibly also animated or acoustically output reactions live and during the playback of the transmission in progress.

According to a further aspect, the reactions of the users can be selectively associated with one of the parties of a transmitted sporting event and intelligently aggregated by a cloud server, that is to say, statistically compressed to give a representative overall mood among the users, for example by means of a moving average formation with a specified or dynamic window or other temporal smoothing, in which the most recent reactions carry the highest weight, so as to also achieve a “cooling effect” of the reaction output.

### BRIEF DESCRIPTION OF THE DRAWINGS

An exemplary embodiment of the invention is shown in the drawings and is described in further detail below.

FIG. 1 shows the flow chart of the method according to one embodiment of the invention.

FIG. 2 shows a schematic representation of user reaction aggregation.

FIG. 3 shows an exemplary overview of the data transmission and input/output devices.

### DETAILED DESCRIPTION OF THE INVENTION

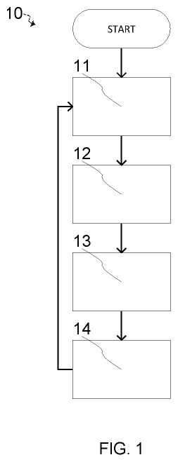

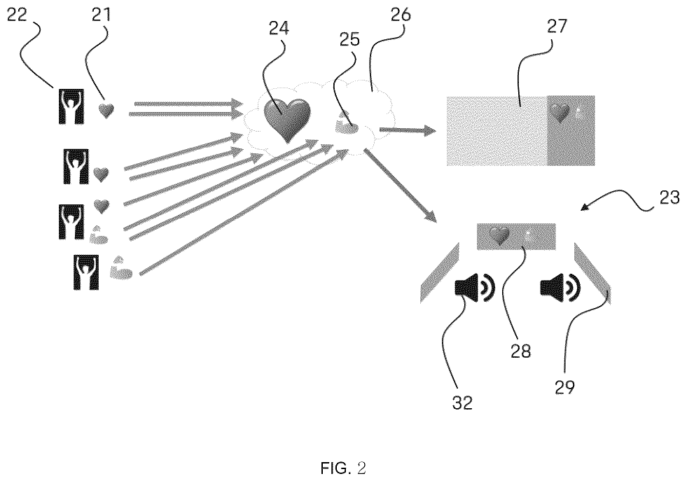

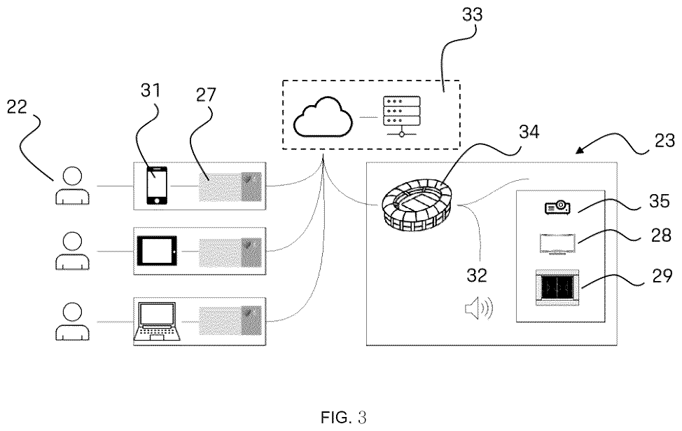

FIGS. 1 to 3 illustrate the basic steps of a method according to the invention. The latter can now be explained on the basis of a sporting event (23), whose real-time transmission is watched by viewers at different locations simultaneously.

During the playback (process 11) of the real-time transmission, the reactions (21) of the users (22) on their clients (31)—such as mobile terminal devices such as laptops, tablet computers, or smartphones—are recorded by a mobile app or web application (27) (process 12). This can, in the simplest case, be done by an interaction of the respective user (22) with a graphical user interface of his or her client (31), such as a mouse click on one of a plurality of specified texts, emojis, or other images, or a tapping or swiping gesture on a touchscreen. The optical detection of corresponding gestures or facial expressions of the user (22) by the client (31) is also contemplated.

Here, the user (22) can express his or her reaction (21) in general or in relation to one of the parties (24, 25) involved in the sporting event (23), for example an individual player or a team. A similar assignment would be conceivable in the context of a festival broadcast, for example relating to a particular artist.

The reactions (21) recorded in this manner are transmitted to a cloud server (33) and are statistically compressed by the latter to give a representative overall mood (26). This aggregation (process 13) can comprise, for example, a moving average formation with a dynamic window or an exponential smoothing.

The overall mood (26) thus compiled can finally be presented in a variety of ways. For example, the display can be carried out in the web component or mobile app (27) of the remote viewers as well as at the event location (34), in particular for the viewers on site and participating parties, via LED walls (28), bands (29) or other display devices (35) as well as speakers (32) (process 14).

1-12. (canceled)

13. A method for reflecting public mood in a real-time transmission of an event, said method comprising:
simultaneously playing the real-time transmission on a plurality of clients,
recording reactions of users during the real-time transmission,
statistically compressing on a server the recorded reactions to give a representative overall mood among the users, and
conveying the overall mood on a display.

14. The method according to claim 13, wherein the clients comprise mobile terminal devices and the recording and conveying are carried out by a mobile app or web application.

15. The method according to claim 14, wherein the mobile terminal devices each comprise a laptop, the mobile terminal devices each comprise a tablet computer, or the mobile terminal devices each comprise a smartphone.

16. The method according to claim 14, wherein the mobile terminal devices each comprise an AR or VR headset, and the reaction is recorded by the headset by way of a gesture, speech, or eye tracking.

17. The method according to claim 13, wherein the event is a multi-party sporting event, and the reactions are selectively assigned by the users to one of the parties of the multi-party sporting event.

18. The method according to claim 13, wherein the event is a competition show or electoral event.

19. The method according to claim 13, wherein either the display is carried out visually or the display is carried out acoustically.

20. The method according to claim 13, wherein the statistical compression comprises a moving average formation with a dynamic window, or the statistical compression comprises an exponential smoothing.

21. The method according to claim 13, wherein the recording comprises an interaction of the users with a graphical user interface of the clients, or the recording comprises optical detection of gestures or facial expressions of the users by the clients.

22. A client for carrying out the method according to claim 13, wherein each client comprises means for playback of the real-time transmission, means for recording the reactions, and means for conveying the overall mood.

23. A computer program configured to carry out a method for reflecting public mood in a real-time transmission of an event, said method comprising:
simultaneously playing the real-time transmission on a plurality of clients,
recording reactions of users during the real-time transmission,
statistically compressing on a server the recorded reactions to give a representative overall mood among the users, and
conveying the overall mood on a display.

24. A machine-readable storage medium having the computer program according to claim 23 stored thereon.
